(19) United States
(12) Patent Application Publication
(10) Pub. No.: US 2010/0308093 A1
(43) Pub. Date: Dec. 9, 2010

(54) AUGER HAULER

(76) Inventor: James Johnson, Otter Lake, MI (US)

Correspondence Address: Bliss McGlynn, P.C., Suite 600, 2075 West Big Beaver Road, Troy, MI, 48084, US

(21) Appl. No.: 12/479,931

(22) Filed: Jun. 8, 2009

(51) Int. Cl. B60R 9/06

(52) U.S. Cl. 224/408; 224/492; 224/519; 224/525; 224/537

(57) ABSTRACT

An auger hauler is adapted to be removably attached to a vehicle and transport an auger with the vehicle. The auger hauler comprises a vehicle frame that is adapted to be removably attached to the vehicle. The auger hauler comprises further an auger frame attached to the vehicle frame and adapted to transport the auger.

### BACKGROUND OF INVENTION

1. Field of Invention

The invention relates, generally, to a device for hauling an auger and, more particularly, to such a device adapted to be removably attached to a snowmobile.

2. Description of Related Art

It is known in the sport of ice fishing to use a hand-held, powered auger for drilling holes through ice into which lines, hooks, and lures are dropped and from which fish are withdrawn. Because such auger is generally bulky, heavy, and large, manually hauling it to a point of use of the auger—such as a particular ice-fishing site—can be difficult. Accordingly, an all-terrain vehicle (ATV) or snowmobile is typically used for such hauling.

The ATV or snowmobile may have a cargo or luggage rack upon which to haul the auger. However, the rack can be unsatisfactory on its own to haul the auger such that the auger frequently needs to be manually tied to the rack with, say, rope or bungee cord. Furthermore, because the auger is usually made of metal, the auger can scratch the rack during loading onto and unloading from the rack of the auger.

Alternatively, the auger is often towed with a shanty and other ice-fishing equipment—such as buckets, a chair, containers, fishing poles, a portable heater, pails, and a propane tank—behind the ATV or snowmobile across the ice and other types of terrain to the site. More specifically, the auger and other equipment are usually stored inside the shanty, which is then so towed. However, because the shanty is towed (often substantial distances) across and in direct contact with the terrain, which many times includes of rough surfaces, the auger and other equipment are continually banged against such surfaces, each other, or interior walls of the shanty during the towing and, thus, prone to being damaged or even ruined.

As a result, it is known in the related art to use an auger hauler to transport the auger to the site. Such auger hauler generally is assembled and mounted to the ATV or snowmobile. The auger hauler generally also can consist of many separate structural parts, including pins.

Although the auger hauler of the related art facilitates transportation of an auger, the auger hauler can interfere with normal operation of the ATV or snowmobile, and use of the auger hauler can be limited to transportation of the auger. Furthermore, the auger hauler can be cumbersome. In particular, the auger hauler can require (after assembly and mounting thereof to the ATV or snowmobile) disassembly and re-assembly of the auger hauler, pulling of the pins and/or repositioning of the parts of the auger hauler, adjustment of the auger hauler with respect to the ATV or snowmobile, etc.

The auger hauler of the related art can also be mounted on a top of the rack of the ATV or snowmobile or be connected to a hitch mount of the ATV or snowmobile. Moreover, such auger hauler can be mounted so that the auger is centered on a lower rear portion of the ATV or snowmobile. Consequently, the ATV or snowmobile cannot transport other cargo or pull a trailer without the auger and/or auger hauler being removed from the ATV or snowmobile.

Thus, there is a need in the related art for an auger hauler that can be removably attached to, transported by, and operated from various types of vehicles, including an ATV or a snowmobile. There is a need in the related art for such an auger hauler that also does not interfere with normal operation of the vehicle. There is a need in the related art for such an auger hauler use of which is not limited to transportation of an auger. There is a need in the related art for such an auger hauler that also is not cumbersome. In particular, there is a need in the related art for such an auger hauler that does not also require assembly, disassembly, and re-assembly of the auger hauler; pulling of pins and/or repositioning of parts of the auger hauler; adjustment of the auger hauler with respect to the vehicle, etc. There is a need in the related art for such an auger hauler that also allows the vehicle to transport other cargo or pull a trailer without the auger and/or auger hauler being removed from the vehicle. There is a need in the related art for such an auger hauler that is also relatively easy and quick to attach to the vehicle and operate. There is a need in the related art for such an auger hauler that can also fit various makes and models of a particular type of vehicle. There is a need in the related art for such an auger hauler that is also strong, durable, and lightweight.

### SUMMARY OF INVENTION

The invention overcomes the disadvantages in the related art in an auger hauler adapted to be removably attached to a vehicle and transport an auger with the vehicle. The auger hauler comprises a vehicle frame that is adapted to be removably attached to the vehicle. The auger hauler comprises further an auger frame attached to the vehicle frame and adapted to transport the auger.

One advantage of the auger hauler of the invention is that it can be removably attached to, transported by, and operated from various types of vehicles, including an ATV or a snowmobile.

Another advantage of the auger hauler of the invention is that it does not interfere with normal operation of the vehicle.

Another advantage of the auger hauler of the invention is that use thereof is not limited to transportation of an auger.

Another advantage of the auger hauler of the invention is that it is not cumbersome.

Another advantage of the auger hauler of the invention is that it does not require assembly, disassembly, and re-assembly of the auger hauler; pulling of pins and/or repositioning of parts of the auger hauler; adjustment of the auger hauler with respect to the vehicle, etc.

Another advantage of the auger hauler of the invention is that it allows the vehicle to transport other cargo or pull a trailer without the auger and/or auger hauler being removed from the vehicle.

Another advantage of the auger hauler of the invention is that it is relatively easy and quick to attach to the vehicle and operate.

Another advantage of the auger hauler of the invention is that it can fit various makes and models of a particular type of vehicle.

Another advantage of the auger hauler of the invention is that it is strong, durable, and lightweight.

Other objects, features, and advantages of the auger hauler of the invention will be readily appreciated as the same becomes better understood while reading the subsequent description taken in conjunction with the accompanying drawings.

### BRIEF DESCRIPTION OF EACH FIGURE OF DRAWING

FIG. 1 is an environmental view of an embodiment of an auger hauler of the invention showing the auger hauler removably attached to a rear portion of a snowmobile, transporting an auger with the snowmobile, including first and second platforms carrying storage space, and connected to a shanty.

FIG. 2 is a perspective view of another embodiment of the auger hauler of the invention showing the auger hauler including a single platform and a hitch mount (without a hitch).

FIG. 3 is a partial environmental view of another embodiment of the auger hauler of the invention showing the auger hauler removably attached to a rear portion of a snowmobile (shown in phantom), transporting an auger (shown in phantom) with the snowmobile, and including no platform; a hitch mount of the auger hauler connected to and extending from the rear portion of the snowmobile; and storage space supported behind the hitch mount.

FIG. 4 is a perspective view of another embodiment of the auger hauler of the invention showing the auger hauler including a single platform carrying storage space and a hitch mount (with a hitch).

### DETAILED DESCRIPTION OF EMBODIMENTS OF INVENTION

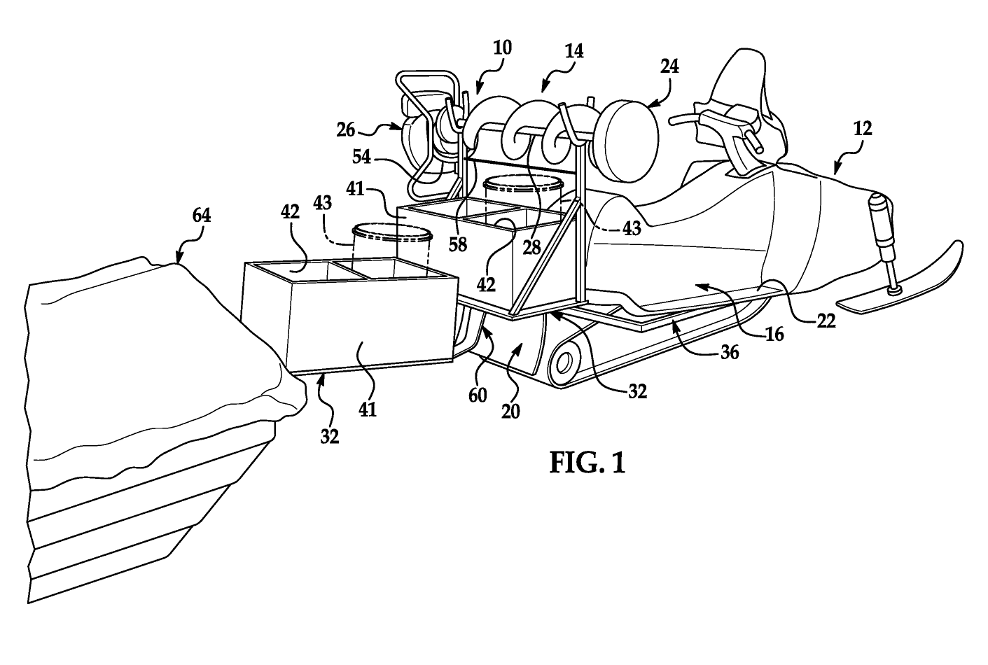

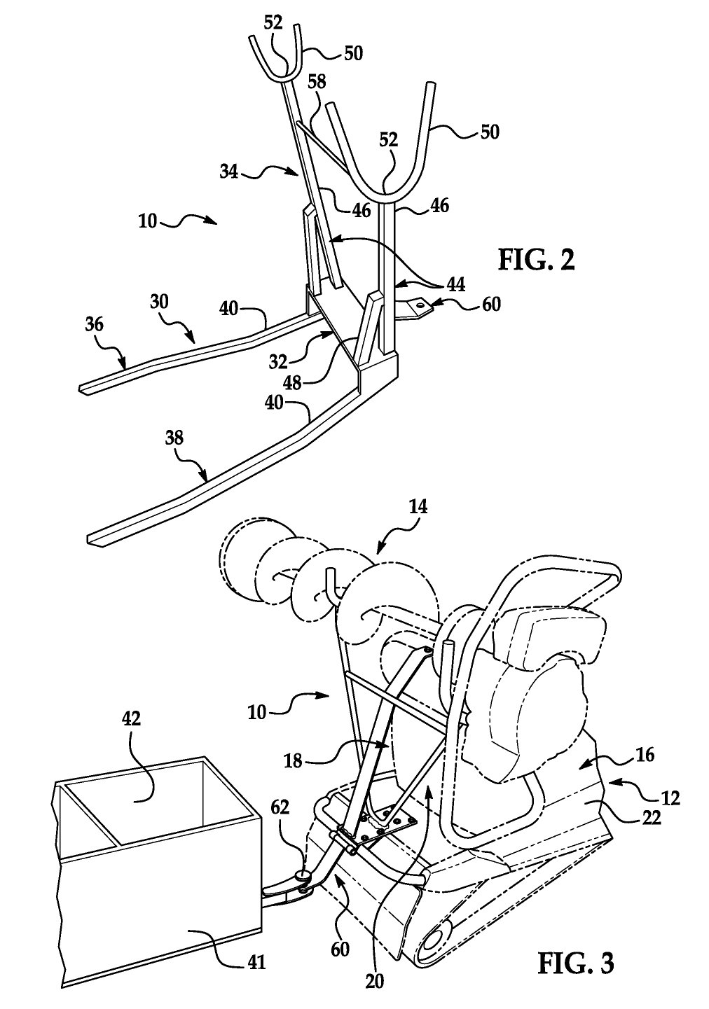

Referring now to FIGS. 1 and 3, an auger hauler according to the invention is generally indicated at 10. The auger hauler 10 is adapted to be removably attached to a vehicle, generally indicated at 12, and transport an auger, generally indicated at 14, with the vehicle 12. The vehicle 12 described below and shown in the figures is a snowmobile 12 that defines a pair of opposed side portions, generally indicated at 16, 18, and a rear portion, generally indicated at 20, of the snowmobile 12 to which the auger hauler 14 is removably attached. (Only side portion 16 is shown in FIG. 1.) Each side portion 16, 18 of the snowmobile 12 includes a running board 22 extending along a lower part of the side portion 16, 18. The snowmobile 12 further includes a source of electrical power (not shown) and at least one taillight (not shown). The auger 14 defines a pair of opposed end portions, generally indicated at 24, 26, and a main shaft 28 of the auger 14. The auger hauler 10 described below and shown in the figures is intended to be used in an ice-fishing environment.

It should be appreciated by those having ordinary skill in the technology to which the auger hauler 10 pertains that the auger hauler 10 can be employed with any suitable type of vehicle. By way of example only and not by way of limitation, the auger hauler 10 can be employed with any suitable all-terrain vehicle (ATV), such as a quad-bike (also commonly referred to as a “four-wheeler”). It should be so appreciated also that the snowmobile 12 can have any suitable shape, size, and structure. It should be so appreciated also that the auger hauler 10 can transport any suitable auger, in particular, and any suitable object, in general. It should be so appreciated also that snowmobiles and augers are well-known. It should be so appreciated also that the snowmobile 12 and auger 14 play no part in and, thus, are not structural elements of the invention. It should be so appreciated also that the auger hauler 10 can be used in any suitable environment and is not limited to use in connection with only ice fishing.

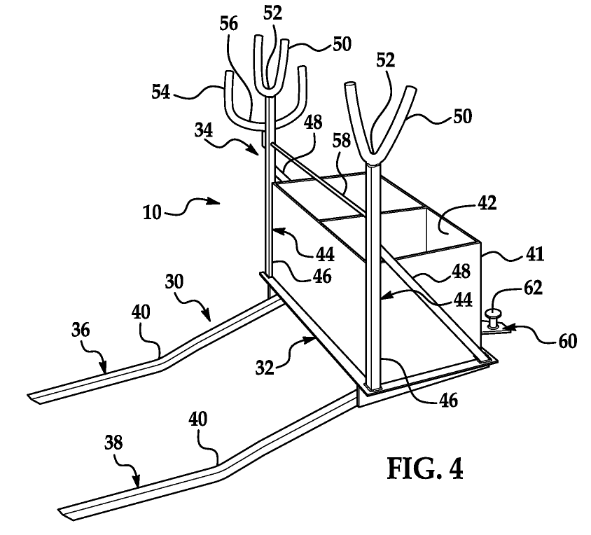

Referring now to FIGS. 2 and 4, the auger hauler 10 generally comprises a vehicle frame, generally indicated at 30, that is adapted to be removably attached to the snowmobile 12. The auger hauler 10 comprises further an auger frame, generally indicated at 34, attached to the vehicle frame 32 and adapted to transport the auger 14.

More specifically, the vehicle frame 30 includes a pair of opposed supporting arms, generally indicated at 36, 38, that are uniform with respect to each other and adapted to be removably attached—say, bolted—to the respective side portions 16, 18 of the snowmobile 12 adjacent the corresponding running boards 22. The supporting arms 36, 38 shown in FIG. 4 are disposed substantially parallel with each other. However, the supporting arms 36, 38 shown in FIG. 2 are disposed substantially non-parallel with each other. Each of the supporting arms 36, 38 may define at least one bend 40 in the supporting arm 36, 38. (Each of the supporting arms 36, 38 shown in FIGS. 2 and 4 defines a single bend.) Of course, the structural relationship of the supporting arms 36, 38 with each other and the particular design of (including the number of bends in and location of each bend of) each supporting arm 36, 38 depends upon the particular design of the respective side portions 16, 18 and, to a certain extent, corresponding running boards 22 of the snowmobile 12.

The vehicle frame 30 includes further at least one platform, generally indicated at 32, adapted to carry items. To that end, the platform 32 is substantially planar and operatively disposed substantially parallel with and a desired distance above a surface (not shown), such as ground, upon which the snowmobile 12 travels. The platform 32 also is disposed a desired distance from and extends a desired distance away from the rear portion 20 of the snowmobile 12. In this way, the platform 32 can carry hauling containers (not shown), such as crates, of varying shapes and sizes. Also, in one embodiment of the auger hauler 10, the supporting arms 36, 38 of the vehicle frame 30 are attached to the platform 32, as shown in FIGS. 1, 2, and 4. Preferably, the supporting arms 36, 38 are securely attached—say, integral—with the platform 32.

FIG. 1 shows the vehicle frame 30 including first and second platforms 32, and FIG. 4 shows the vehicle frame 30 including a single platform 32. In either case, each platform 32 carries an “open top” box 41 that is divided into a pair of substantially equal storage compartments each of which defines a desired amount of storage space 42. Although only a bucket 43 (container or pail) is shown in FIG. 1, poles, a seat, and other items related to ice fishing can be stored in the box 41 as well (including a lid for the bucket 43 that has at least one half-moon-slide latch adapted to hold a fishing pole in place within the bucket 43). Alternatively, the vehicle frame 30 can include further a housing 41 defining the storage space(s) 42 and a floor (not shown) that is at least part of the platform 32. Preferably, the housing 41 is integral with the platform 32. The ice-fishing-related items are adapted to be stored in the storage space(s) 42. In addition to those identified above, such items can include, but are no means limited to, a portable heater and a propane tank (not shown).

It should be appreciated by those having ordinary skill in the technology to which the auger hauler 10 pertains that the vehicle frame 30, in general, and each of the supporting arms 36, 38, platform 32, and housing 41, in particular, can have any suitable shape, size, and structure. It should be so appreciated also that the vehicle frame 30 can have any suitable structural relationship with the snowmobile 12 and each of the supporting arms 36, 38, platform 32, and housing 41 can have any suitable structural relationship with each other. It should be so appreciated also that the vehicle frame 30 can be constructed as “standard” such that the vehicle frame 30 is removably attachable to a particular suitable type of snowmobile 12 or as “customized” such that the vehicle frame 30 is removably attachable to any suitable snowmobile 12. To this end, it should be so appreciated also that the vehicle frame 30, in general, and each of the supporting arms 36, 38, in particular, can include a universal joint or universal joints. It should be so appreciated also that the vehicle frame 30 can be removably attached to the snowmobile 12, in general, and the supporting arms 36, 38 can be removably attached to the respective side portions 16, 18 adjacent the corresponding running boards 22 of the snowmobile 12, in particular, by any suitable means. It should be so appreciated also that the auger hauler 10 can include any suitable number of platforms 32 or no platform, as shown in FIG. 3.

Referring now to FIGS. 2 and 4, the auger frame 34 includes a pair of opposed supporting structures, generally indicated at 44, attached to the vehicle frame 30 and adapted to operatively support the respective end portions 24, 26 of the auger 14. More specifically, the supporting structures 44 are uniform with respect to each other, and extend substantially parallel with each other a desired distance above the platform 32. Preferably, the supporting structures 44 are securely attached—say, integral with—the platform 32.

In particular, each of the supporting structures 44 includes a supporting member 46 extending substantially vertically from the platform 32 and adapted to operatively support the corresponding end portion 24, 26 of the auger 14. The supporting members 44 are disposed at respective corners of the platform 32. (Such corners are shown defined opposite the corresponding supporting arms 36, 38 of the vehicle frame 30 in FIG. 2 and shown defined proximate the corresponding supporting arms 36, 38 in FIG. 4.)

Each of the supporting structures 44 includes further a structural member 48 securely attached to and extending a desired distance between the platform 32 and supporting member 46 and adapted to provide structural integrity to the auger frame 34. Preferably, the structural member 48 is integral with the platform 32 and respective supporting member 46. In FIG. 2, each structural member 48 is shown disposed between the corresponding supporting arm 36, 38 and supporting member 46 and intersected with the supporting member 46 below a midsection of the supporting member 46 and at an angle no greater than about forty-five degrees with respect to the supporting member 46. In FIG. 4, each structural member 48 is shown disposed opposite the respective supporting arm 36, 38 relative to the corresponding supporting member 46 and intersected with the supporting member 46 above a midsection of the supporting member 46 and at an angle of approximately forty-five degrees with respect to the supporting member 46. In this way, the platform 32 forms an approximate right triangle with the supporting member 46 and structural member 48. Of course, such relationship among the platform 32, supporting member 46, and structural member 48 is a matter of design choice. The embodiment of the auger hauler 10 shown in FIG. 3 does not include the structural members 48.

Each of the supporting structures 44 includes further a holding member 50 adapted to operatively hold the corresponding end portion 24, 26 of the auger 14. More specifically, each of the supporting structures 44 defines an end portion of the supporting structure 44 disposed opposite the vehicle frame 30, and the holding member 50 is disposed on the end portion of the supporting structure 44. In particular, an end portion of the supporting member 46 defines the end portion of the supporting structure 44 and is disposed opposite the platform 32. Preferably, the holding member 50 is integral with the end portion of the supporting member 46. The holding member can be a “U” member 50, as shown in FIG. 2, or a “V” member 50, as shown in FIG. 4. In either case, the holding member 50 defines a vertex portion 52 of the holding member 50, and a part of the main shaft 28 of the corresponding end portion 24, 26 of the auger 14 is adapted to be operatively positioned upon the vertex portion 52 such that the vertex portion 52 frictionally holds the main shaft 28.

Of course, length of legs of the holding member 50 and size of radius of the vertex portion 52 are a matter of design choice, depending in large part upon dimensions of the subject part of the auger 14. It should be appreciated by those having ordinary skill in the technology to which the auger hauler 10 pertains that each holding member 50 can be covered with a gripping material (not shown), like friction tape, that can assist the holding member 50 to grip the subject part of the auger 14.

As best shown in FIG. 1, the auger frame 34 includes further a bearing member 54 operatively disposed adjacent either of the end portions 24, 26 of the auger 14 and adapted to operatively help bear weight of the end portion 26. (The end portion 26 is the part of the auger 14 that includes a motor and other power-related components of the auger 14 and, thus, defines a disproportionate amount of the total mass and volume of the auger 14.) More specifically, the bearing member 54 is disposed adjacent and lower than one of the holding members 50 opposite the other holding member 50. In particular, the bearing member 54 extends integrally outward and upward from a corresponding supporting member 46. Like with the holding member 50, the bearing member can be a “U” (or “V”) member 54, as shown in FIGS. 1 and 4, defining a vertex portion 56 (best shown in FIG. 4) of the bearing member 54, and the end portion 26 of the auger 14 is adapted to be operatively positioned upon the vertex portion 56 such that the vertex portion 56 frictionally holds the end portion 26. The embodiment of the auger hauler 10 shown in FIG. 2 does not include the bearing member 54.

Of course, like with the holding member 50, length of legs of the bearing member 54 and size of radius of the vertex portion 56 are a matter of design choice, depending in large part upon dimensions of the end portion 26 of the auger 14. It should be appreciated by those having ordinary skill in the technology to which the auger hauler 10 pertains that, like with the holding member 50, each bearing member 54 can be covered with a gripping material (not shown), like friction tape, that can assist the bearing member 54 to grip the end portion 26 of the auger 14.

The auger frame 34 includes further a cross member 58 securely attached to and extending between the supporting structures 44 and adapted to provide structural integrity to the auger frame 34. In particular, the cross member 58 extends between the supporting members 46 a desired distance above the platform 32. The cross member 58 is also integral with and substantially perpendicular to the supporting members 46. In the figures, the cross-member 58 is shown located closer to the holding members 50 than to the platform 32.

It should be appreciated by those having ordinary skill in the technology to which the auger hauler 10 pertains that the auger frame 34, in general, and each of the supporting structures 44 (including each of the supporting, structural, and holding members 46, 48, 50), bearing member 54, and cross member 58, in particular, can have any suitable shape, size, and structure. It should be so appreciated also that the auger frame 34 can have any suitable structural relationship with each of the auger 14 and vehicle frame 30 and each of the supporting structures 44 (including each of the supporting, structural, and holding members 46, 48, 50), bearing member 54, and cross member 58 can have any suitable structural relationship with each other. It should be so appreciated also that the auger frame 34 can be constructed as “standard” such that the auger frame 34 can transport a particular suitable type of auger or as “customized” such that the auger frame 34 can transport any suitable auger.

In another embodiment of the auger hauler 10 and as best shown in FIGS. 2 and 4, the vehicle frame 30 includes further a hitch mount, generally indicated at 60, extending from the platform 32 and defining an end portion of the hitch mount 60 disposed opposite the platform 32. Whereas FIG. 4 shows the hitch mount 60 including a hitch 62 disposed on the end portion of the hitch mount 60, FIG. 2 shows the hitch mount 60 not including the hitch 62. In another embodiment of the auger hauler 10 and as shown in FIG. 1, the hitch mount 60 extends from the first platform 32, and the second platform 32 is disposed upon the hitch mount 60. In another embodiment of the auger hauler 10 and as best shown in FIG. 3, the hitch mount 60 is connected to and extends from the rear portion 20 of the snowmobile 12. In each of these embodiments, the hitch mount 60 is adapted to connect the snowmobile 12 to, say, a shanty, generally indicated at 64 in FIG. 1. As shown in FIG. 3, the box 41 can be carried by a hitch assembly supported by the shanty 64, which, in turn, is connected to the auger hauler 10.

The auger hauler 10 comprises further an electrical connector (not shown) being in electrical communication with the snowmobile 12 and adapted to provide electrical power to the taillight(s) of the snowmobile 12. More specifically, the electrical connector can be a pigtail extending from the vehicle frame 30. The auger hauler 10 is made preferably of steel for more strength and durability or aluminum for lighter weight of the auger hauler 10.

It should be appreciated by those having ordinary skill in the technology to which the auger hauler 10 pertains that the hitch mount 60 can have any suitable shape, size, and structure and structural relationship with the snowmobile 12 and remainder of the vehicle frame 30. It should be so appreciated also that the hitch 62 can have any suitable shape, size, and structure and structural relationship with the hitch mount 60 and connect the snowmobile 12 to any suitable object. It should be so appreciated also that the platform 32 can be disposed upon the hitch mount 60 in any suitable location and manner. It should be so appreciated also that the electrical connector can have any suitable location on the auger hauler 10, be in electrical communication with any suitable source of power, and be any suitable device. It should be so appreciated also that the auger hauler 10, in general, and each structural element of the auger hauler 10, in particular, can be made of any suitable material, such as metal.

In operation of the auger hauler 10, the auger hauler 10 is, say, easily and quickly bolted to the snowmobile 12 such that the supporting arms 36, 38 of the vehicle frame 30 are removably attached to and extend along the respective side portions 16, 18 of the snowmobile 12 and the supporting structures 44 of the auger frame 34 abut or nearly abut the rear portion 20 of the snowmobile 12. In this way, an entirety of the auger hauler 10 is disposed above the ground upon which the snowmobile 12 travels, and the auger hauler 10 does not interfere with normal operation of the snowmobile 12. The auger 14 is then easily and quickly positioned upon the vertex portions 52, 56 of the corresponding holding members 50 and bearing member 54 of the auger frame 34, which frictionally hold the main shaft 28 of the corresponding end portions 24, 26 of the auger 14 and help bear the weight of the end portion 26 of the auger 14, respectively. In this way, the auger 14 does not scratch the auger hauler 10 or snowmobile 12 during loading onto (and unloading from) the auger hauler 10 of the auger 14, and the auger 14 does not need to be manually tied to the auger hauler 10 with, say, rope or bungee cord such that the auger hauler 10 is satisfactory on its own to haul the auger 14.

A pair of buckets 43 (containers or pails), poles, a seat, and/or other ice-fishing-related items can be carried by the platform 32 or stored within the storage space 42 of the housing 41, and/or the snowmobile 12 can be connected to the shanty 64 via the hitch 62. Ultimately, the snowmobile 12 travels to a desired ice-fishing site, where the auger 14 is easily and quickly unloaded from the auger hauler 10 and, in turn, snowmobile 12 and used for drilling holes through ice. The other ice-fishing-related items are easily and quickly unloaded from the auger hauler 10 as they are needed. When attachment of the auger hauler 10 to the snowmobile 12 is no longer desired, the auger hauler 10 can be easily and quickly removed from the snowmobile 12 by unbolting the supporting arms 36, 38 of the vehicle frame 30 from the respective side portions 16, 18 of the snowmobile 12.

It should be appreciated by those having ordinary skill in the art to which the auger hauler 10 pertains that the auger hauler 10 can be attached to the snowmobile 12 in any suitable manner. For example, the platform 32 can be removably attached—say, bolted—to the rear portion 20 of the snowmobile 12. It should be so appreciated also that the auger hauler 10 can be operatively disposed above the ground any suitable distance. It should be so appreciated also that the holding members 50 and bearing member 54 of the auger frame 34 can hold the auger 14 in any suitable manner. It should be so appreciated also that the auger 14 can be manually tied to the auger hauler 10 to assist the auger frame 34 in holding the auger 14 and help bear the weight of the end portion 26 of the auger 14.

The auger hauler 10 can be removably attached to, transported by, and operated from various types of vehicles, including an ATV or a snowmobile. Also, the auger hauler 10 does not interfere with normal operation of the snowmobile 12. And, use of the auger hauler 10 is not limited to transportation of the auger 14. Furthermore, the auger hauler 10 is not cumbersome. In particular, the auger hauler 10 does not require assembly, disassembly, and re-assembly of the auger hauler 10; pulling of pins and/or repositioning of parts of the auger hauler 10; adjustment of the auger hauler 10 with respect to the snowmobile 12, etc. In addition, the auger hauler 10 allows the snowmobile 12 to transport other cargo or pull the shanty 64 without the auger 14 and/or auger hauler 10 being removed from the snowmobile 12. Moreover, the auger hauler 10 is relatively easy and quick to attach to the snowmobile 12 and operate. Plus, the auger hauler 10 can fit various makes and models of the snowmobile 12. The auger hauler 10 is strong, durable, and lightweight as well.

The auger hauler 10 has been described in an illustrative manner. It is to be understood that the terminology that has been used is intended to be in the nature of words of description rather than of limitation. Many modifications and variations of the auger hauler 10 are possible in light of the above teachings. Therefore, within the scope of the appended claims, the auger hauler 10 may be practiced other than as specifically described.

What is claimed is:

1. An auger hauler adapted to be removably attached to a vehicle and transport an auger with the vehicle, said auger hauler comprising:
a vehicle frame adapted to be removably attached to the vehicle; and
an auger frame attached to said vehicle frame and adapted to transport the auger.

2. Said auger hauler as set forth in claim 1, wherein the vehicle defines a pair of opposed side portions of the vehicle and said vehicle frame includes a pair of opposed supporting arms adapted to be removably attached to the respective side portions of the vehicle.

3. Said auger hauler as set forth in claim 2, wherein said vehicle frame includes at least one platform.

4. Said auger hauler as set forth in claim 3, wherein said supporting arms are attached to said at least one platform.

5. Said auger hauler as set forth in claim 3, wherein said vehicle frame includes a housing defining storage space and a floor that is at least part of said at least one platform.

6. Said auger hauler as set forth in claim 1, wherein the auger defines a pair of opposed end portions of the auger and said auger frame includes a pair of opposed supporting structures attached to said vehicle frame and adapted to operatively support the respective end portions of the auger.

7. Said auger hauler as set forth in claim 6, wherein each of said supporting structures includes a supporting member extending from said vehicle frame and adapted to operatively support the corresponding end portion of the auger and a structural member attached to and extending between said vehicle frame and supporting member and adapted to provide structural integrity to said auger frame.

8. Said auger hauler as set forth in claim 7, wherein each of said supporting structures includes a holding member adapted to operatively hold the corresponding end portion of the auger.

9. Said auger hauler as set forth in claim 8, wherein each of said supporting structures defines an end portion of said supporting structure disposed distal said vehicle frame and said holding member is disposed on said end portion of said supporting structure.

10. Said auger hauler as set forth in claim 9, wherein an end portion of said supporting member defines said end portion of said supporting structure and is disposed distal said vehicle frame.

11. Said auger hauler as set forth in claim 8, wherein the auger includes a main shaft, said holding member is either of a “V” and “U” member defining a vertex portion of said holding member, and a part of the main shaft of the corresponding end portion of the auger is adapted to be operatively positioned upon said vertex portion such that said vertex portion frictionally holds the main shaft.

12. Said auger hauler as set forth in claim 8, wherein said auger frame includes a bearing member operatively disposed adjacent either of the end portions of the auger and adapted to operatively bear weight of the end portion.

13. Said auger hauler as set forth in claim 12, wherein said bearing member is disposed adjacent either of said holding members opposite other of said holding members.

14. Said auger hauler as set forth in claim 6, wherein said auger frame includes a cross member attached to and extending between said supporting structures and adapted to provide structural integrity to said auger frame.

15. Said auger hauler as set forth in claim 3, wherein said vehicle defines a rear portion of the vehicle to which said auger hauler is removably attached and said vehicle frame includes a hitch mount extending from said at least one platform, defining an end portion of said hitch mount disposed distal said at least one platform, and including a hitch disposed on said end portion.

16. Said auger hauler as set forth in claim 15, wherein said vehicle frame includes first and second platforms, said hitch mount extends from said first platform, and said second platform is disposed upon said hitch mount.

17. Said auger hauler as set forth in claim 1, wherein said vehicle defines a rear portion of the vehicle and said auger hauler includes a hitch mount connected to and extending from the rear portion of the vehicle.

18. Said auger hauler as set forth in claim 1, wherein said auger hauler comprises an electrical connector being in electrical communication with the vehicle and adapted to provide electrical power to at least one taillight of the vehicle.

19. Said auger hauler as set forth in claim 1, wherein said auger hauler is made of either of steel and aluminum.

20. Said auger hauler as set forth in claim 1, wherein said auger hauler is removably attached to either of a snowmobile and quad-bike.
